(19) United States
(12) Patent Application Publication
(10) Pub. No.: US 2015/0017944 A1
(43) Pub. Date: Jan. 15, 2015

(54) Flexible Device Upgrade Plan

(71) Applicant: T-Mobile USA, Inc., Bellevue, WA (US)

(72) Inventors: Roger Brown, Bellevue, WA (US); Christopher Luz, Bellevue, WA (US); Matthew A. Staneff, Clyde Hill, WA (US); Dale L. Quick, Redmond, WA (US); Zhuqing Zhang, Issaquah, WA (US)

(21) Appl. No.: 14/327,346

(22) Filed: Jul. 9, 2014

Related U.S. Application Data
(60) Provisional application No. 61/844,316, filed on Jul. 9, 2013.

(51) Int. Cl. H04M 15/00

(52) U.S. Cl. CPC H04M 15/81
USPC 455/406

(57) ABSTRACT

Described herein are techniques for receiving, by a telecommunication service provider, used telecommunication devices from a plurality of subscribers of the telecommunication service provider. The used telecommunication devices may each have been purchased with an installment plan on which a balance is owed, and different balances may be owed on different ones of the used telecommunication devices. In exchange for the used telecommunication devices, the telecommunication service provider may pay off up to at least part of each of the balances. Further, prior to paying off the balances, the telecommunication service provider may obtain identifiers for the used telecommunication devices and verify that the obtained identifier for each used telecommunication device matches an identifier that is associated with one of the subscribers and is stored in a data store of the telecommunication service provider.

### RELATED APPLICATIONS

This application claims priority to U.S. provisional patent application No. 61/844,316, entitled “Anytime Upgrade” and filed on Jul. 9, 2013. Application No. 61/844,316 is fully incorporated herein by this reference.

### BACKGROUND

Subscribers of telecommunication service providers often sign up for a service agreement of a fixed duration (e.g., one year, two years, etc.) in exchange for purchase of a telecommunication device at a free or discounted rate. The telecommunication service provider then recuperates the cost of the telecommunication device through regular payments from the subscriber over the period of the service agreement. If the subscriber wishes to purchase a new telecommunication device during that service contract (e.g., because the device is technologically obsolete), then that subscriber must pay the full cost of the new telecommunication device. Also, if the device is damaged, lost, or stolen during the service agreement, the subscriber must purchase a new telecommunication device, unless the subscriber has insurance for the damaged, lost, or stolen telecommunication device.

Other telecommunication service providers may enable subscribers to purchase telecommunication devices on financing, such as installment plans, without a service agreement for a fixed duration. But if those subscribers wish to purchase new telecommunication devices before the original telecommunication devices are fully paid off, they must still continue payments for the old telecommunication devices while starting payments for the new ones.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of a subscriber purchasing a telecommunication device on an installment plan, purchasing a device upgrade plan with that device, and utilizing that device upgrade plan on multiple, subsequent occasions to replace the subscriber's telecommunication device.

FIG. 2 illustrates relationships between entities, devices, and payments involved in providing the benefits of a device upgrade plan to subscribers of a telecommunication service provider.

FIG. 3 illustrates an example process for creating a device upgrade plan for a subscriber, receiving a telecommunication device from the subscriber, and, in exchange for the telecommunication device, paying off at least a part of the balance of an installment plan for the telecommunication device in accordance with the device upgrade plan.

FIG. 4 illustrates a component level view of a computing device of the telecommunication service provider.

### DETAILED DESCRIPTION

This disclosure describes, in part, techniques for a telecommunication service provider to pay off at least a part of a remaining balance of an installment plan for a telecommunication device in exchange for the subscriber relinquishing the telecommunication device to the telecommunication service provider. To ensure that the telecommunication device being relinquished is the same telecommunication device covered by the installment plan, the telecommunication service provider may obtain an identifier for the telecommunication device, such as an International Mobile Subscriber Equipment Identity (IMEI) number, a Mobile Equipment Identifier (MEID), a Cellular Data Number (CDN), a Mobile Device Number (MDN), or an Integrated Circuit Card Identifier (ICCID), and verify whether there is a match by comparing it to an identifier for the telecommunication device stored by a data store of the telecommunication service provider. The telecommunication service provider may then provide the relinquished telecommunication device to a third party which may reimburse the telecommunication service provider the amount of the pay off. The third party may then repair the relinquished telecommunication device and sell it as a refurbished telecommunication device.

In various implementations, the pay off and relinquishment are tied to whether the subscriber has purchased a device upgrade plan. Different device upgrade plans may be associated with different pay offs, numbers of times that a subscriber can upgrade, and wait periods. For example, one device upgrade plan may require a six month wait from the initial purchase of a telecommunication device, allow two upgrades after that six month period, and pay off the complete balance of the installment plan for each device being relinquished as part of an upgrade. In another example, a device upgrade plan may allow any number of upgrades with no wait period, but may only pay off a part of the balance up to a set threshold (e.g., fifty percent) of the original purchase price or installment plan principal for the telecommunication device being relinquished. Device upgrade plans may also either include an insurance component for the telecommunication device associated with the installment plan or require a subscriber to purchase insurance for the telecommunication device associated with the installment plan.

In further implementations, when a subscriber with a device upgrade plan and insurance presents a damaged or broken telecommunication device to a telecommunication service provider, the telecommunication service provider may provide the subscriber with the option to either replace the damaged or broken telecommunication device or to upgrade to a new telecommunication device in exchange for relinquishing the damaged or broken telecommunication device. The upgrade would include pay off of at least a part of the balance of the installment plan for the damaged or broken telecommunication device. The new telecommunication device could then be purchased under a new installment plan and associated with the device upgrade plan.

### Overview

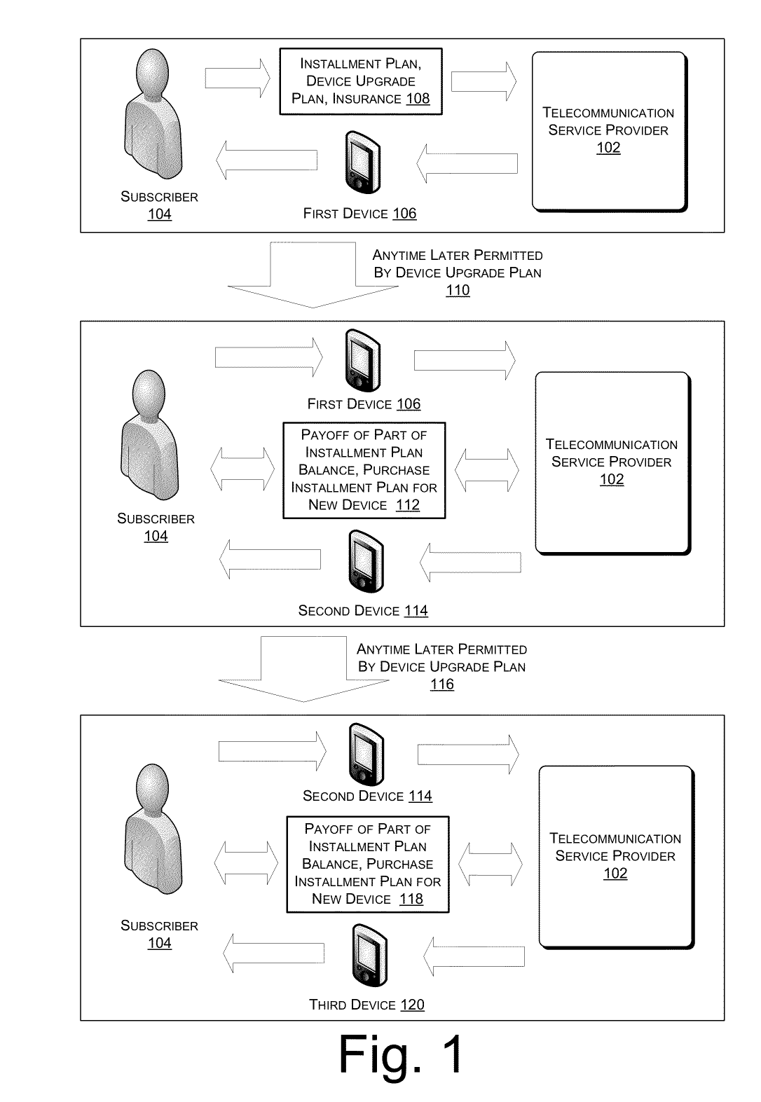

FIG. 1 illustrates an overview of a subscriber purchasing a telecommunication device on an installment plan, purchasing a device upgrade plan with that device, and utilizing that device upgrade plan on multiple, subsequent occasions to replace the subscriber's telecommunication device. As illustrated, a telecommunication service provider 102 may provide a subscriber 104 with an opportunity to purchase a telecommunication device (such as first device 106). In exchange for the first device 106, the subscriber 104 may pay a down payment and agree to an installment plan 108. The subscriber may also sign up for a device upgrade plan and insurance 108, either at the time of purchasing the first device 106 or at a later time.

In various implementations, the telecommunication service provider 102 may be a provider of telecommunication services, operating access networks, a backhaul, and a core network that provide wireless communication services to its subscribers. Alternatively, the telecommunication service provider 102 may be a reseller of services of another telecommunication service provider. The telecommunication service provider 102 may operate a physical store or a website to sell telecommunication devices and to enable subscribers to sign up for service plans, insurance plans, etc.

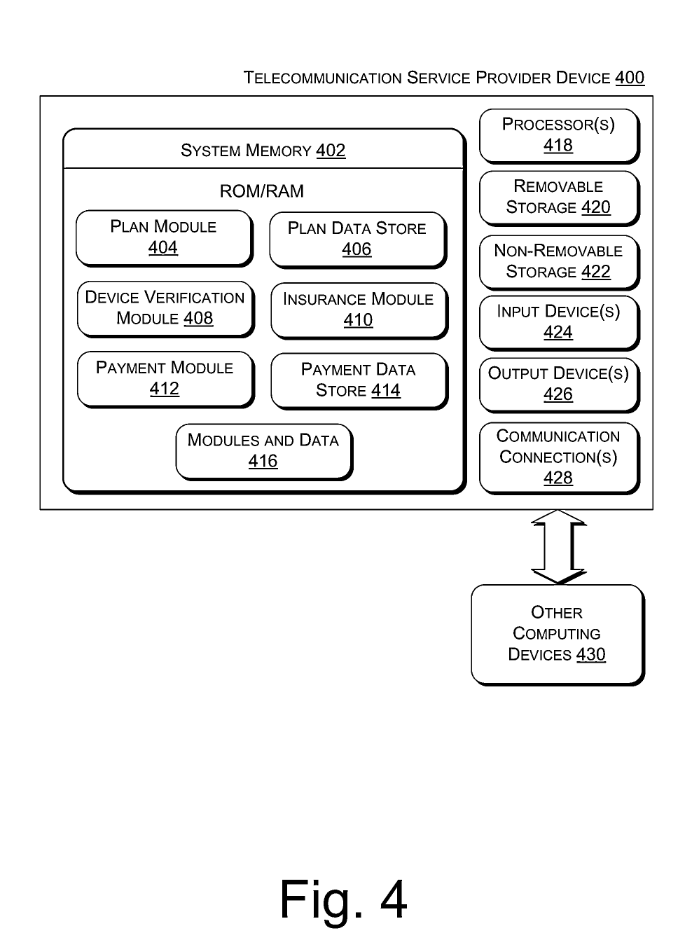

The telecommunication service provider 102 may also have computing device(s) configured to enable at least plan offering and management, device identification, and payments. For example, such computing device(s) of the telecommunication service provider 102 may each be or include a server or server farm, multiple, distributed server farms, a mainframe, a work station, a personal computer (PC), a laptop computer, a tablet computer, an embedded system, or any other sort of device or devices. In one implementation, the computing device(s) of the telecommunication service provider 102 include a plurality of computing devices working in communication, such as a cloud computing network of nodes. An example computing device of the telecommunication service provider 102 is illustrated in FIG. 4 and is described in detail below with reference to that figure.

In further implementations, the first device 106 and other telecommunication devices illustrated in FIG. 1 may each be any sort of telecommunication device. For example, the telecommunication devices may each be or include a cellular phone, a smart phone, a media player, an electronic reading device, a PC, a laptop computer, a tablet computer, or any other sort of device or devices. The telecommunication device(s) may also be or include wearable devices, such as wristbands, watches, etc. which may be able to communicate via services of the telecommunication service provider 102 either by direct wireless communication with a base station or access point or indirectly through another telecommunication device. Any subscriber 104 may acquire one or more such telecommunication devices at the same time, in sequence, or both.

The subscriber 104 may acquire the first device 106 for an existing line or service account with the telecommunication service provider 102 or for a new line or account. When purchasing the first device 106 and associating it with the line or service account, the telecommunication service provider 102 may capture information about the first device, such as a telecommunication device identifier (e.g., an IMEI number, a MEID, a CDN, a MDN, or an ICCID). The telecommunication service provider 102 may do this by having personnel either scan the telecommunication device identifier or textually or graphically enter the telecommunication device identifier. The telecommunication service provider 102 may then store the telecommunication device identifier and other device information in association with the first device 106, with information about the line or service account, and with information about the subscriber 104.

The installment plan 108 used to purchase the first device 106 may require an initial down payment and may call for regular payments thereafter (e.g., monthly payments, etc.). The installment plan may also have a repayment period by the end of which the first device 106 is to be paid off.

The device upgrade plan 108 may be acquired at the time of the purchase of the first device 106 or later. The device upgrade plan 108 may be specific to a line or service account and associated with that line or service account and with the first device 106. In some implementations, the telecommunication service provider 102 acts as a broker in the device upgrade plan 108, with the actual agreement being between the subscriber 104 and a third party. The terms of the device upgrade plan 108 may vary, but each may involve some pay off of at least a part of the balance of the installment plan 108 being provided to the subscriber 104 in exchange for the subscriber relinquishing the telecommunication device currently associated with the device upgrade plan 108 (e.g., first device 106). The device upgrade plan 108 may also require that the subscriber 104 obtain insurance 108 for the telecommunication device currently associated with the device upgrade plan 108 (e.g., first device 106). Such insurance 108 may be part of the device upgrade plan 108 or may be a separate plan acquired by the subscriber 108.

In various implementations, an example device upgrade plan 108 may require a wait period (e.g., six months) from the initial purchase of the telecommunication device (e.g., first device 106), allow two upgrades after that wait period, and pay off the complete balance of the installment plan 108 for each device being relinquished as part of an upgrade. In another example, a device upgrade plan 108 may allow any number of upgrades with no wait period, but may only pay off a part of the balance up to a set threshold (e.g., fifty percent) of the original purchase price of the telecommunication device (e.g., first device 106) being relinquished.

At a later time 110, such as anytime later that is permitted by the device upgrade plan 108 (e.g., after a wait period), the subscriber 104 may relinquish the first device 106 in exchange for a pay off 112 of at least a part of the balance of the installment plan 108 for the first device. As describe in greater detail herein, this may involve obtaining the identifier of the telecommunication device being relinquished and verifying that it is the first device 106. The subscriber 104 may then purchase a second device 114, which may also be a telecommunication device, via an installment plan 112, which may be similar to the above-described installment plan 108. The telecommunication service provider 102 may then obtain the telecommunication device identifier of the second device 114 and associate it with the device upgrade plan 108.

At a later time 116, such as anytime later that is permitted by the device upgrade plan 108 (e.g., anytime, even the day after the later time 110, so long as a limit on the number of upgrades per a time period has not been reached), the subscriber 104 may relinquish the second device 114 in exchange for a pay off 118 of at least a part of the balance of the installment plan 108 for the second device 116. This pay off 118 may be different than the pay off 112 based either on the balance remaining or on the initial principal of the installment plans of the first and second devices 106 and 114. As describe in greater detail herein, this may involve obtaining the identifier of the telecommunication device being relinquished and verifying that it is the second device 114. The subscriber 104 may then purchase a third device 120, which may also be a telecommunication device, via an installment plan 118, which may be similar to the above-described installment plans 108 and 112. The telecommunication service provider 102 may then obtain the telecommunication device identifier of the third device 120 and associate it with the device upgrade plan 108.

### Example Entities

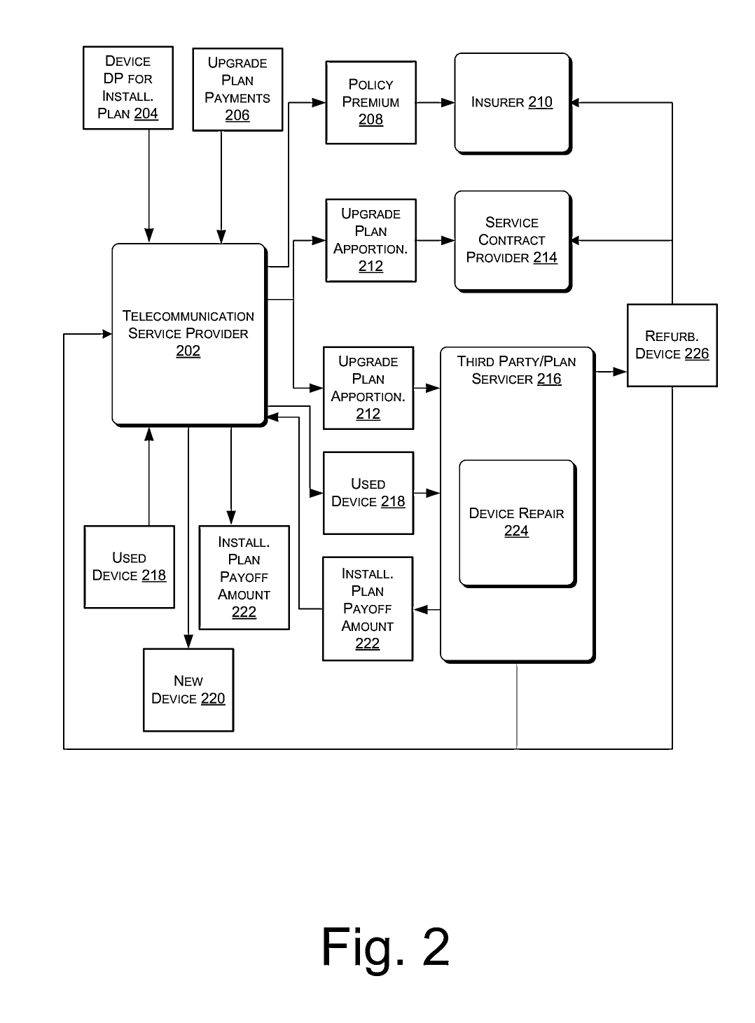

FIG. 2 illustrates relationships between entities, devices, and payments involved in providing the benefits of a device upgrade plan to subscribers of a telecommunication service provider. As illustrated, a telecommunication service provider 202 (which may, for instance, be an example of telecommunication service provider 102) may receive a down payment 204 for a telecommunication device during an initial purchase of the telecommunication device. The telecommunication device may, for example, be $500 and the subscriber may pay $100 in a down payment and elect to finance the remaining $400 balance using an installment plan. The installment plan may involve, for example, a $20 monthly payment. At the time of the purchase (or later), the subscriber may elect to enroll in a device upgrade plan. As part of the enrollment, the telecommunication service provider may obtain the telecommunication device identifier (e.g., an IMEI number, a MEID, a CDN, a MDN, or an ICCID) for the purchased telecommunication device and store it in association with the device upgrade plan.

In some implementations, the device upgrade plan may include an extended service contract and insurance. The extended service contract may be an agreement between a service contract provider and the subscriber to cover accidental damage or manufacturer defects, both in and out of any warranty which may accompany the telecommunication device. The insurance may be a group policy purchased by the telecommunication service provider 202, may be given to subscribers that purchase the device upgrade plan or other service plans, and may cover, for instance, theft and loss. Further, as described herein, the device upgrade plan may have (A) a wait period, a limit on the number of upgrades per a time period, and full pay off of any balance on the installment plan or (B) no waits or limits on the number and timing of upgrades, but only a pay off of up to a set percentage (e.g., fifty percent) of the initial principal of the installment plan or device purchase price.

In various implementations, the telecommunication service provider 202 may receive monthly upgrade plan payments 206 from the subscriber. Such payments could be, for example, $10 a month. The payments 206 may be billed and collected by the telecommunication service provider 202 as part of the monthly service charges. The telecommunication service provider 202 may retain a portion of this collected amount (e.g., $2 a month) and bear the bad debt risk for non-collection.

The telecommunication service provider 202 may also make payments to other entities on behalf of its subscribers. For example, the telecommunication service provider 202 may pay a group policy premium 208 to an insurer 210. The insurer 210 may be any sort of insurance entity that includes both service personnel and technology supporting the insurance services, such as computing devices maintain policy information. Also, the telecommunication service provider 202 may apportion the payments 206 received for the device upgrade plan and pay 212 those apportioned payments to each of a service contract provider 214 and a third party/upgrade plan servicer 216. Each of the service contract provider 214 and the third party 316 may be any sort of entity that includes both service personnel and technology supporting the services, such as computing devices maintain service contract, telecommunication device, or upgrade plan information, as applicable. For example, the telecommunication service provider 202 may pay $5 out of the $10 monthly payment as an apportioned payment 212 to the service contract provider 214 and may pay $3 out of the $10 monthly payment as an apportioned payment 212 to the third party 216. The telecommunication service provider 202 may retain $2 out of the $10 monthly payment for its services. The payments 212 may be made on a monthly basis after they are received from the subscriber.

In further implementations, when the subscriber elects to exercise the upgrade option under the device upgrade plan, the subscriber may bring the used telecommunication device 218 to a store or other facility of the telecommunications service provider 202 may mail the used telecommunication device in. Personnel of the telecommunication service provider 202 (or personnel at a third party service center, if mailed in) may then examine the used telecommunication device 218. The personnel may obtain the telecommunication device identifier (e.g., an IMEI number, a MEID, a CDN, a MDN, or an ICCID) from the used telecommunication device 218, either through scanning, text entry, or image capture, and provide it to systems of the telecommunication service provider 202 to verify that the telecommunication device identifier for the used telecommunication device 218 matches a telecommunication device identifier stored in associated with the device upgrade plan. The personnel may also determine if the used telecommunication device 218 has water damage, a cracked screen, or doesn't power on. If the used telecommunication device 218 has any of this damage, the telecommunication service provider 202 may offer the subscriber the option of replacing the used telecommunication device 218 via the insurance or electing to upgrade to a new telecommunication device 220. If the subscriber elects to use the insurance, the personnel may ask the subscriber to pay a fee equal to the deductible for the used telecommunication device 218. When the subscriber proceeds with the upgrade, the personnel collect the used telecommunication device 218 and provide, in return, a pay off 222 of at least a part of the balance of the installment plan. The calculation of this pay off 222 is described in greater detail further herein.

The subscriber may then elect to purchase a new telecommunication device 220, again paying a down payment and agreeing to an installment plan. The customer may further maintain the device upgrade plan. The personnel may scan or otherwise obtain the telecommunication device identifier of the new telecommunication device 218 and provide it to the telecommunication service provider 202 for the telecommunication service provider 202 to update the telecommunication device identifier stored in association with the device upgrade plan.

In various implementations, the telecommunication service provider 202 may then send the used telecommunication device 218 to the third party 216 and receive an amount equal to the pay off 222. The telecommunication service provider 202 may also provide transaction information about the upgrade to the third party 216. Also, if the telecommunication service provider 202 collects any damaged device fees for damages to the used telecommunication device 218 not covered by subscriber plans, the telecommunication service provider 202 may provide those amounts to the third party 216. Device repair capabilities 224 of the third party 216 may then make any repairs or refurbishments to the used telecommunication device 218 to make the used telecommunication device 218 marketable. Alternatively, the third party 216 may sell the unrepaired/unrefurbished used telecommunication device 218 to the telecommunication service provider 202. If making repairs or refurbishments, the third party 216 may then sell or otherwise provide the used telecommunication device 218 as a refurbished telecommunication device 226 to other parties, such as the insurer 210, the service contract provider 214, or the telecommunication service provider 202. For example, the third party may sell the refurbished telecommunication device 226 to the insurer 210 or service contract provider 214, which may then use the refurbished telecommunication device 226 as a like, replacement telecommunication device for insurance claims

### Example Processes

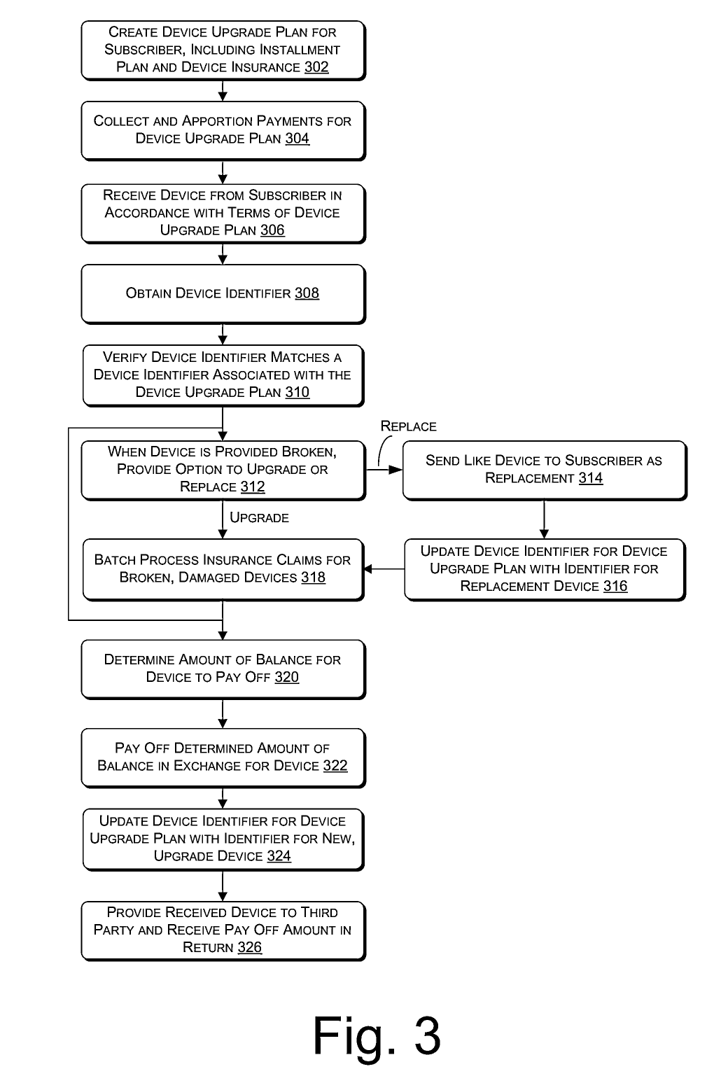

FIG. 3 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 3 illustrates an example process for creating a device upgrade plan for a subscriber, receiving a telecommunication device from the subscriber, and, in exchange for the telecommunication device, paying off at least a part of the balance of an installment plan for the telecommunication device in accordance with the device upgrade plan. The process may include, at 302, creating a device upgrade plan for a subscriber of a telecommunication service provider. The subscriber may have a telecommunication device purchased on an installment plan and, at the time of purchase or later, may also elect to acquire a device upgrade plan for the telecommunication device. The device upgrade plan may enable the subscriber to purchase, relinquish, and pay off multiple consecutive telecommunication devices at times chosen by the subscriber. Also, in some implementations, pay off of a part of the balance of the installment plan by the telecommunication service provider may be performed conditionally based on whether the subscriber has acquired a device upgrade plan. To acquire the device upgrade plan, the telecommunication service provider may also require that the subscriber acquire an insurance plan for the telecommunication device covered by the device upgrade plan. Such an insurance plan may be part of the device upgrade plan or may be a separate plan.

At 304, the telecommunication service provider may collect and apportion payments for the device upgrade plan. In some implementations, the apportioned payments may then be provided to one or both of (A) an extended service plan provider or insurer responsible for an insurance plan for the telecommunication device of a subscriber or (B) a third party that has promised to accept the telecommunication device, when relinquished, and to provide the pay off of at least a part of the balance of the installment plan to the subscriber through the telecommunication service provider. The telecommunication service provider may also keep a part of the collected payment as compensation for its services.

At 306, the telecommunication service provider may receive the telecommunication device from the subscriber as a relinquished, used telecommunication device which may have a balance remaining on its installment plan. In some implementations, the subscriber may have been required to wait for at least a period of time in accordance with the device upgrade plan before relinquishing the telecommunication device for an upgrade. In other implementations, no wait is required and the subscriber may relinquish the telecommunication device at any time after its purchase. Further, different subscribers may choose to relinquish their telecommunication devices at different times, with different balances left on different installment plans for those telecommunication devices.

At 308, to verify that the telecommunication device received from the subscriber is the telecommunication device associated with the device upgrade plan, the telecommunication service provider may obtain a telecommunication device identifier for the received telecommunication device. The telecommunication service provider may obtain the telecommunication device identifier by receiving a scan of the telecommunication device identifier (e.g., from personnel of the telecommunication service provider) or by receiving text or image input of the telecommunication device identifier (e.g., from personnel of the telecommunication service provider). In some implementations, the (e.g., from personnel of the telecommunication service provider) device identifier may be an IMEI number, a MEID, a CDN, a MDN, or an ICCID.

At 310, the telecommunication service provider may verify that the obtained telecommunication device identifier matches a telecommunication device identifier stored in association with the device upgrade plan. If there is a match, the telecommunication service provider may assume that the received telecommunication device is the telecommunication device associated with the device upgrade plan. The telecommunication device identifier stored in association with the device upgrade plan may be stored in a data store of the telecommunication service provider.

At 312, if the subscriber presents the telecommunication device in a broken or damaged state, the telecommunication service provider may provide the subscriber with an alternative to replace the telecommunication device with a like telecommunication device based on the insurance or to upgrade to a new telecommunication device based on the device upgrade plan.

At 314, if the subscriber elects to replace the broken or damaged telecommunication device, the telecommunication service provider may send a like telecommunication device to the subscriber as a replacement in return for relinquishing the broken or damaged telecommunication device. In other implementations, there may be no involvement of the telecommunication service provider, with the subscriber interacting directly with an insurer, relinquishing the telecommunication device to the insurer and receiving the like telecommunication device in return from the insurer. At 316, when the broken or damaged telecommunication device is received by the telecommunication service provider, the telecommunication service provider may update the telecommunication device identifier stored in association with the device upgrade plan to the telecommunication device identifier of the like, replacement telecommunication device.

At 318, regardless of whether the subscriber elects to replace or upgrade the broken or damaged telecommunication device, the telecommunication service provider may then batch process claims for broken or damaged telecommunication devices, including the subscriber's broken or damaged telecommunication device, performing inspections of those devices, filing claims to the insurer, and automatically receiving payment from the insurer based on the inspections.

At 320, when the subscriber is upgrading to a new telecommunication device in accordance with the device upgrade plan, the telecommunication service provider may next determine the pay off amount for the telecommunication device. The pay off amount may cover at least a part of the balance of the installment plan. In some implementations, the device upgrade plan may specify that the entire balance is to be paid. Such device upgrade plans may also specify an initial wait period and limit the number of upgrades per a time period, however. In other implementations, the device upgrade plan may cap the pay off amount at a set percentage (e.g., fifty percent) of the initial purchase price of the telecommunication device or of the initial principal of the installment plan. The set percentage may be the same for different installment plans with different balances. Further, because different subscribers may choose to relinquish their telecommunication devices at different times, the pay offs for different subscribers may also vary. The telecommunication service provider may then pay up to, but not above, that amount. With such a device upgrade plan, there may be no wait period or no limit on the number of times that a subscriber may choose to upgrade to a new telecommunication device.

At 322, the telecommunication service provider may then pay off the determined amount of the balance in exchange for the relinquished telecommunication device. The subscriber may then purchase a new, upgrade device on a new installment plan and may, if chosen, continue the device upgrade plan and associate the new telecommunication device with the device upgrade plan.

At 324, the telecommunication service provider may update the telecommunication device identifier stored in association with the device upgrade plan to the telecommunication device identifier of the new telecommunication device.

At 326, the telecommunication service provider may provide the telecommunication device to a third party (such as the third party receiving apportioned payments) and, in return, receive an amount corresponding to the at least the part of the balance (e.g., the pay off amount).

### Example Devices

FIG. 4 illustrates a component level view of a computing device 400 of the telecommunication service provider 102. As illustrated, the computing device 400 comprises a system memory 402 storing a plan module 404, a plan data store 406, a device verification module 408, an insurance module 410, a payment module 412, a payment data store 414, and one or more modules and data 416. Also, the computing device 400 includes processor(s) 418, a removable storage 420, a non-removable storage 422, input device(s) 424, output device(s) 426, and communication connections 428 to one or more other computing devices 430.

In various examples, system memory 402 may be volatile (such as RAM), non-volatile (such as ROM, flash memory, etc.) or some combination of the two.

The plan module 404 may implement any of the installment plan, device upgrade plan, extended service contract, and insurance plan creation functionality of the telecommunication service providers 102 and 202 described above in detail with regard to FIGS. 1 and 2. For example, the plan module 404 may create entries in data stores for subscribers, plans, and devices and populate those data stores with information obtained from telecommunication service provider personnel.

The plan data store 406 may represent any data store(s) of information associated with subscribers, plans, and devices that are maintained by the telecommunication service providers 102 and 202 described above in detail with regard to FIGS. 1 and 2.

The device verification module 408 may implement any of the telecommunication device identifier obtaining, verification, and updating functionality of the telecommunication service providers 102 and 202 described above in detail with regard to FIGS. 1 and 2. For example, the device verification module 408 may both verify the telecommunication device identifier of a device being relinquished and replace the telecommunication device identifier stored in the plan data store with the telecommunication device identifier of the new telecommunication device acquired as part of the upgrade.

The insurance module 410 may implement any of the insurance claims processing functionality of the telecommunication service providers 102 and 202 described above in detail with regard to FIGS. 1 and 2.

The payment module 412 may implement any of the plan payment collection and apportionment, pay off amount determination, pay off amount pay out and receipt functionality of the telecommunication service providers 102 and 202 described above in detail with regard to FIGS. 1 and 2.

The payment data store 414 may represent any data store(s) of information associated with payment plans and balances that are maintained by the telecommunication service providers 102 and 202 described above in detail with regard to FIGS. 1 and 2. For example, the payment data store 212 may have a profile associated with a billing account number of a subscriber. That profile may include representations of equipment credit available, an equipment credit balance, an equipment credit limit, and representations of one or more service line identifiers, such as Mobile Subscriber International Subscriber Directory Numbers (MSISDNs). Each MSISDN may in turn be associated with equipment credit available, an equipment credit balance, an equipment credit limit and one or more installment plan identifiers corresponding to installment plans for different telecommunication devices. Each installment plan identifier may in turn be associated with a telecommunication device identifier, such as an IMEI number, a MEID, a CDN, a MDN, or an ICCID, for the telecommunication device associated with that installment plan, and an equipment credit balance which may track a balance of that installment plan.

Any number of other systems and components of a telecommunication service provider 102 or 202 may be included in modules and data 416, such as self-care systems, logistics systems, retail systems, customer care systems, business-to-business systems, analytics systems, back office systems, bill presentation systems, and other billing systems in addition to the payments module 412 and payments data store 414. Further, the modules and data 416 may also comprise any sort of applications or platform components of the computing device 400, as well as data associated with such applications or platform components.

In some examples, the processor(s) 418 may be a central processing unit (CPU), a graphics processing unit (GPU), or both CPU and GPU, or any other sort of processing unit.

The computing device 400 may also include additional data storage devices (removable and/or non-removable) such as, for example, magnetic disks, optical disks, or tape. Such additional storage is illustrated in FIG. 4 by removable storage 420 and non-removable storage 422.

Non-transitory computer-readable media may include volatile and nonvolatile, removable and non-removable tangible, physical media implemented in technology for storage of information, such as computer readable instructions, data structures, program modules, or other data. System memory 402, removable storage 420 and non-removable storage 422 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the computing device 400. Any such non-transitory computer-readable media may be part of the computing device 400.

In various examples, input devices 424 may include any sort of input devices known in the art. For example, input devices 424 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

In some examples, the output devices 426 may include any sort of output devices known in the art, such as a display (e.g., a liquid crystal display), speakers, a vibrating mechanism, or a tactile feedback mechanism. Output devices 426 may also include ports for one or more peripheral devices, such as headphones, peripheral speakers, or a peripheral display.

Computing device 400 also contains communication connections 428 that allow the computing device 400 to communicate with other computing devices 430, such as device(s) of the telecommunication device 102, the first device 106, second device 114, third device 120, or any of the devices and entities illustrated in FIG. 2.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. A method comprising:
receiving, by a telecommunication service provider, used telecommunication devices from a plurality of subscribers of the telecommunication service provider, wherein the used telecommunication devices have each been purchased with an installment plan on which a balance is owed and different balances are owed on different ones of the used telecommunication devices;
obtaining, by the telecommunication service provider, a telecommunication device identifier for each of the used telecommunication devices;
verifying, by the telecommunication service provider, that the obtained telecommunication device identifier for each used telecommunication device matches a telecommunication device identifier that is associated with one of the subscribers and is stored in a data store of the telecommunication service provider; and
in exchange for the used telecommunication devices, paying off, by the telecommunication service provider, up to at least part of each of the balances.

2. The method of claim 1, further comprising determining the at least the part of each of the balances by applying a set percentage to each of the corresponding initial principle amounts of the installment plans, wherein the set percentage is the same for installment plans with different balances.

3. The method of claim 1, wherein the telecommunication device identifiers of the used telecommunication devices include at least one of international mobile station equipment identity (IMEI) numbers, mobile equipment identifiers (MEIDs), cellular data numbers (CDNs), mobile device numbers (MDNs), or integrated circuit card identifiers (ICCIDs), and the obtaining comprises scanning the at least one of the IMEI numbers, MEIDs, CDNs, MDNs, or ICCIDs, or receiving the at least one of the IMEI numbers, MEIDs, CDNs, MDNs, or ICCIDs as entered by personnel of the telecommunication service provider.

4. The method of claim 1, further comprising providing the used telecommunication devices to a third party and, in return, receiving amounts corresponding to the at least the parts of the balances.

5. The method of claim 1, wherein the paying off for one of the used telecommunication devices is performed conditionally based on whether the subscriber for one of the used telecommunication devices is associated with a device upgrade plan.

6. The method of claim 5, wherein the device upgrade plan specifies:
a wait period from an initial purchase of the one of the used telecommunication devices before the one of the used telecommunication devices is eligible for upgrade, and
a limit on number of consecutive telecommunication devices of the subscriber eligible for upgrade in a time period.

7. The method of claim 5, wherein the device upgrade plan specifies that:
the subscriber is eligible for an upgrade at any time following an initial purchase of the one of the telecommunication devices, and
at least the part of the balance for the one of the used telecommunication devices is determined by applying a set percentage to an initial principal amount of the installment plan for the one of the telecommunication devices.

8. The method of claim 5, further comprising collecting and apportioning payments associated with the device upgrade plan.

9. The method of claim 5, wherein the device upgrade plan enables the subscriber to purchase, relinquish, and pay off multiple consecutive telecommunication devices at times chosen by the subscriber.

10. The method of claim 5, wherein the device upgrade plan requires the subscriber to maintain insurance for the at least one of the used telecommunication devices.

11. The method of claim 10, further comprising, when the one of the used telecommunication devices is damaged, providing the subscriber with an alternative to replace the one of the used telecommunication devices with a like telecommunication device based on the insurance or to upgrade to a new telecommunication device based on the device upgrade plan.

12. A system comprising:
one or more processors;
a plan module configured to be operated by at least one of the one or more processors to create a subscription to a device upgrade plan for a subscriber of a telecommunication service provider, the device upgrade plan requiring that the subscriber maintain insurance for a telecommunication device of the subscriber associated with the device upgrade plan and entitling the subscriber to a pay off of at least a part of a balance of an installment plan used to purchase the telecommunication device in exchange for relinquishing the telecommunication device;
a device verification module configured to be operated by at least one of the one or more processors to obtain a telecommunication device identifier from the telecommunication device, when relinquished, and to verify that the obtained telecommunication device identifier matches a telecommunication device identifier associated with the device upgrade plan; and
a payment mode configured to be operated by at least one of the one or more processors to receive and apportion payments associated with the device upgrade plan, to determine the at least the part of the balance of the installment plan based on a set percentage and on an initial principle amount of the installment plan, and to pay off the at least the part of the balance of the installment plan responsive to relinquishment of the telecommunication device,
wherein the device upgrade plan enables the subscriber to purchase, relinquish, and pay off multiple consecutive telecommunication devices at times chosen by the subscriber.

13. The system of claim 12, wherein the device upgrade plan enables the subscriber, when the telecommunication device is damaged, to replace the telecommunication device with a like telecommunication device based on the insurance or to upgrade to a new telecommunication device based on the device upgrade plan.

14. The system of claim 12, wherein the telecommunication device identifier of the telecommunication devices is an IMEI number, a mobile equipment identifier (MEID), a cellular data numbers (CDN), a mobile device numbers (MDN), or an integrated circuit card identifiers (ICCID), and the device verification module obtains the IMEI number, MEID, CDN, MDN, or ICCID by receiving a scan of the IMEI number, MEID, CDN, MDN, or ICCID or receiving the IMEI number, MEID, CDN, MDN, or ICCID as entered by personnel of the telecommunication service provider.

15. The system of claim 12, wherein the plan module replaces the telecommunication device identifier associated with the device upgrade plan in a data store of the telecommunication service provider with a telecommunication device identifier of a new telecommunication device following relinquishing of the telecommunication device and purchase of the new telecommunication device.

16. The system of claim 12, wherein the telecommunication service provider provides the relinquished telecommunication device to a third party and the payment module receives from the third party, in return, an amount corresponding to the at least the part of the balance of the installment plan.

17. A method comprising:
receiving, by a telecommunication service provider, a used telecommunication device from a subscriber of the telecommunication service provider, wherein the used telecommunication device has been purchased with an installment plan on which a balance is owed, is associated with a device upgrade plan and insurance, and is received by the telecommunication service provider in a damaged condition;
providing the subscriber with an alternative to replace the damaged, used telecommunication device with a like telecommunication device based on the insurance or to upgrade to a new telecommunication device based on the device upgrade plan; and
when the subscriber elects to upgrade to the new telecommunication device, paying off up to at least part of the balance in exchange for the damaged, used telecommunication device.

18. The method of claim 17, wherein the telecommunication service provider utilizes substantially real-time batch claim processing for subscribers with damaged, used telecommunication devices regardless of whether the subscribers elect replacement or upgrade.

19. The method of claim 17, further comprising replacing a telecommunication device identifier associated with the device upgrade plan in a data store of the telecommunication service provider with a telecommunication device identifier of the new telecommunication device following relinquishing of the damaged, used telecommunication device and purchase of the new telecommunication device.

20. The method of claim 17, further comprising providing the damaged, used telecommunication device to a third party and, in return, receiving an amount corresponding to the at least the part of the balance.
